(19) United States
(12) Patent Application Publication
(10) Pub. No.: US 2026/0222419 A1
(43) Pub. Date: Jul. 30, 2026

(54) STATISTICAL AND MACHINE LEARNING DETECTION OF ACCESS POINT ATTACKS

(71) Applicant: SAUDI ARABIAN OIL COMPANY, Dhahran (SA)

(72) Inventors: Dakheel Ahmed ALMOGBIL, Dhahran (SA); Ammar ALMULHIM, Dhahran (SA)

(73) Assignee: SAUDI ARABIAN OIL COMPANY, Dhahran (SA)

(21) Appl. No.: 19/038,817

(22) Filed: Jan. 28, 2025

(51) Int. Cl. H04L 9/40; H04L 41/16; H04W 12/122

(52) U.S. Cl. CPC H04L 63/1416; H04L 41/16; H04W 12/122

(57) ABSTRACT

Systems and methods for detecting an access point attack over a wireless network having an access point. A system includes a network traffic monitor that monitors traffic over the wireless network and a machine learning engine having a training stage and an inference stage. The training stage generates a trained machine learning (ML) model based on network data from genuine and malicious sources. The inference stage applies the trained ML model to input data to obtain a predicted value representative of a likelihood of the occurrence of an access point attack. A statistical analyzer analyzes network statistical data to obtain a confidence value representative of a likelihood of the occurrence of an access point attack. An access point attack evaluator evaluates the predicted value and the confidence value to determine the presence of an access point attack, such as, an evil twin access point attack.

### CROSS-REFERENCE TO RELATED APPLICATIONS

None.

### FIELD OF THE DISCLOSURE

The present disclosure relates generally to wireless network security and, more particularly, to access point attack detection and prevention.

### BACKGROUND OF THE DISCLOSURE

Network security is increasingly important to a variety of users, companies and organizations. Data networks are relied upon by devices to communicate and access services over a network. Wireless data networks, such as, Wi-Fi networks, are used to allow different devices to wirelessly connect to a network. This wireless connectivity is often governed according to a well-known standard, such as, a Wi-Fi protocol based on the IEEE 802.11 family of standards. Access points are used to control access to a wireless network. A device wirelessly contacts an access point for access to a wireless network. After identifying data is exchanged according to a communication protocol, access may be granted.

Because of their role as gatekeeper to a wireless network, access points are subject to attacks by malicious or unauthorized actors seeking to gain access to or compromise a wireless data network and its users. One type of attack is called an evil twin attack. An evil twin attack takes place when an attacker sets up a fake Wi-Fi access point for users to connect to, whereupon all the data they share with the network passes through a server controlled by the attacker. The fake Wi-Fi access point (an evil twin) may be configured with the same settings as the original real access point. Attackers can further use de-authentication frames to force users to disconnect from a real access point. Users may then unknowingly re-connect to an evil twin access point, especially since it mimics all of the legitimate access point features and often exhibits a stronger signal to appear more attractive. This can lead to severe consequences, such as the theft of sensitive personal and financial data, leading to identity theft and other forms of fraud. Beyond the individual harm, evil twin attacks can also threaten the security of organizations and businesses.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In one aspect, a system for detecting an access point attack over a wireless network having an access point is disclosed. The system includes a network traffic monitor that monitors traffic over the wireless network and a machine learning engine having a training stage and an inference stage. The training stage generates a trained machine learning (ML) model based on network data from genuine and malicious sources. The inference stage applies the trained ML model to input data to obtain a predicted value representative of a likelihood of the occurrence of an access point attack. The system further includes a statistical analyzer that analyzes network statistical data to obtain a confidence value representative of a likelihood of the occurrence of an access point attack. An access point attack evaluator evaluates the predicted value and the confidence value to determine the presence of an access point attack.

In another aspect, a method for detecting an access point attack over a wireless network having an access point is disclosed. The method includes steps of monitoring network traffic over the wireless network, training a machine learning model based on network data from genuine and malicious sources to obtain a trained ML model, applying input to the trained ML model to obtain a predicted value representative of a likelihood of the occurrence of an access point attack, and analyzing network statistical data to obtain a confidence value representative of a likelihood of the occurrence of an access point attack. The method further includes evaluating the predicted value and the confidence value to determine the presence of an access point attack.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

To easily identify the discussion of any particular element or act, the most significant digit or digits in a reference number refer to the figure number in which that element is first introduced.

FIG. 1 illustrates a wireless network environment having an access point (AP) attack detection system in accordance with one embodiment.

FIG. 2 is a diagram of the AP attack detection system of FIG. 1 shown in greater detail in accordance with one embodiment.

FIG. 3 is a flowchart of a method for detecting an access point attack over a wireless network having an access point, in accordance with one embodiment.

FIGS. 4A and 4B are flowchart diagrams of an AP attack detection method in accordance with one embodiment.

FIG. 5 is a flowchart diagram showing training stage operation in machine learning in accordance with one embodiment.

FIG. 6 is a flowchart diagram showing inference stage operation in machine learning in accordance with one embodiment.

FIG. 7 is a flowchart diagram showing statistical analysis operation in accordance with one embodiment.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

### Terminology

The term “wireless network” as used herein refers to any type of wireless network including, but limited to, a Wi-Fi® network following an IEEE 802.11 type standard for Wi-Fi technology or other Wi-Fi protocol.

The term “packet” refers to any packet of data that can be carried over a packet-switched network.

The term “frame” as used herein refers to a frame of data, such as, any of the different types of frames used in Wi-Fi technology.

The term “access point” or “AP” as used herein refers to any type of access point used for connecting to a wireless network for data communication.

### Access Point Attack Detection

Methods and systems for detecting and preventing access point attacks are disclosed. Machine learning in conjunction with statistical analysis is used to inspect network traffic and detect signs of malicious access points activities. The detected access points attacks can include evil twin access points attacks.

In embodiments, methods and systems involve training a machine learning model on network data from both genuine and malicious sources. Once trained, this model can differentiate between normal and suspicious traffic, using identifiers like unusual packet quantity, size distribution, and predefined packets features gathered from multiple sources that could signal an evil twin. Machine learning and statistical analysis as disclosed herein can significantly enhance the detection and prevention of evil twin attacks. A proactive approach enables the automatic recognition of anomalies in network traffic that are typically associated with a rogue access point. By quickly identifying these threats, individuals and organizations can better protect their data and maintain network integrity.

In embodiments, systems and methods in a first phase monitor network probes and beacons in a promiscuous mode, and extract features from each packet. Connections are made to open wireless networks (such as by a server acting as a client) for the purpose of collecting statistical data. Systems and methods in a second phase prepare data and carry out feature selection and validation. A trained machine learning model decides upon the data collected of the access point whether it is under an evil twin AP attack. If the access point is under evil twin attack, evil twin access point information is collected (e.g., BSSID, Channel, etc.) Statistical analysis is conducted by the server on the access point with no authentication protection using WPA/WPA2 to detect multiple statistical information such as multi-hop detection.

If both machine learning and statistical analysis output indicate the presence of an evil twin attack, then additional verification will be conducted. A comparison of the MAC address and channels is made. In particular, the MAC address and channels are compared with known benign MAC address and channels. If the MAC address is spoofed, the channel of both access points (legitimate and evil twin access point) are seen. If the channel is spoofed, a priority algorithm will be launched to compare the statistical data and the machine learning output.

Systems and methods then alert users of the occurrence of the attack or send a high-confidence alert that requires security team investigation. A host discovery tool may be used to get MAC addresses of all users connected to the legitimate access point. Further, in some applications, an administrator can supply all email addresses for each MAC address connected to the network (such as in a corporate environment). When the host discovery tool gets all MAC addresses of connected devices, an alarm will be sent for only the connected devices for containment and privacy matters.

### AP Attack Detection System

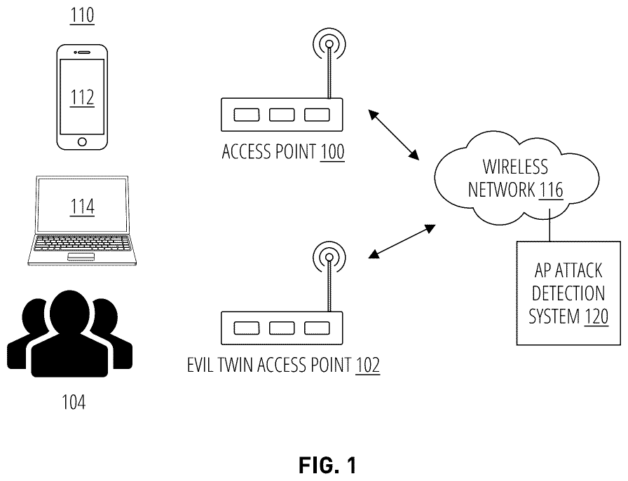

FIG. 1 illustrates a wireless network environment with an access point (AP) attack detection system 120 in accordance with one embodiment. A genuine access point 100 controls access to a wireless network 116. One or more users 104 use devices 110 to communicate over wireless network 116. Wireless network 116 may be further coupled through a server to a wired network, such as, a local area network or the Internet. Devices 110 connect to a legitimate or benign access point 100 to communicate over wireless network 116. Devices 110 may be a smartphone 112 or laptop device 114 as shown in FIG. 1 or other types of computing devices. These examples are not intended to be limiting and other types of devices having wireless communication may be used.

One type of threat a wireless network environment faces is an evil twin access point attack. A malicious access point 102 may be used to try to carry out an evil twin attack. During an evil twin attack, an attacker sets up access point 102 to draw users to connect through access point 102 rather than benign access point 100. The attacker can then use its own server or other resources coupled to access point 102 to capture network traffic data from users 104 over wireless network 116. Such an attack can lead to further consequences, such as, theft of personal or financial data and fraud.

In accordance with a feature, an AP attack detection system 120 is coupled to wireless network 116. In embodiments, AP attack detection system 120 uses machine learning and statistical analysis of network traffic data to detect the presence of AP attacks. In this way, AP attacks, such as an evil twin attack, may be detected more quickly and prevented. This can reduce or eliminate theft, fraud and other harm from malicious attacks.

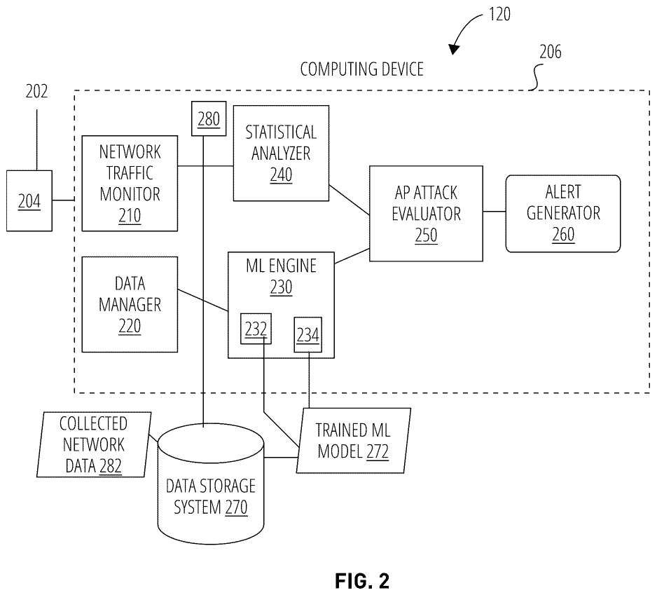

FIG. 2 shows AP attack detection system 120 in greater detail in accordance with one embodiment. AP attack detection system 120 has an antenna 202 coupled to a communication unit 204 and computing device 206. Antenna 202 can transmit and receive wireless data signals to and from a wireless network 116. Communication unit 204 can include a transceiver, network interface and/or packet processing unit for carrying out data communication. Computing device 206 may be a computing device having at least one processor and computer-readable memory.

In one aspect, AP attack detection system 120 further includes components, namely, a network traffic monitor 210, data manager 220, machine learning (ML) engine 230, statistical analyzer 240, AP attack evaluator 250, alert generator 260, data storage system 270, and controller 280. Controller 280 controls operation between each of these components including when to initiate or perform operation of any of the respective components. Controller 280 may be a separate component or may be integrated into one or more of the components in FIG. 2.

Network traffic monitor 210, data manager 220, machine learning (ML) engine 230, statistical analyzer 240, AP attack evaluator 250, alert generator 260 and controller 280 may be each be implemented in software, hardware or any combination thereof. In one embodiment, network traffic monitor 210, data manager 220, machine learning (ML) engine 230, statistical analyzer 240, AP attack evaluator 250, alert generator 260, and controller 280 may be implemented on computing device 206.

Network traffic monitor 210 monitors traffic over wireless network 116. Data manager 220 is coupled to a data storage system 270. Data manager 220 may manage storage and retrieval of data processed by AP attack detection system 120. Data storage system 270 may include one or more databases or other type of data storage. In one example, data storage system 270 can store collected network statistical data and/or a trained ML model 272.

ML engine 230 has a training stage 232 and an inference stage 234. Training stage 232 generates a trained machine learning (ML) model 272 based on network data from genuine and malicious sources. Inference stage 234 applies the trained ML model 272 to input data to obtain a predicted value representative of a likelihood of the occurrence of an access point attack.

Statistical analyzer 240 analyzes network statistical data to obtain a confidence value representative of a likelihood of the occurrence of an access point attack.

AP attack evaluator 250 is coupled to receive output from ML engine 230 and statistical analyzer 240. AP attack evaluator 250 evaluates the predicted value and the confidence value to determine the presence of an access point attack. In a further feature, access point AP attack evaluator 250 may determine whether at least one of an address (such as a MAC address) or a channel of an access point device has been spoofed.

Alert generator 260 is coupled to AP attack evaluator 250 and generates an alert indicative of the presence of an access point attack based on output from access point AP attack evaluator 250. The alert may be an indication of the presence of an access point attack. The alert may be sent in a message over email, text or other data communication. The alert may also be a visual, audio, tactile, or other form of indication depending upon a particular application. Alert generator 260 may also output a recommendation message or initiate a countermeasure, such as, a denial of service (DOS) attack to further thwart the AP attack.

### Operation

In operation, AP attack detection system 120 is coupled to receive network traffic data carried over wireless network 116 as input data. Network traffic monitor 210 may initiate promiscuous mode monitoring of network traffic on the wireless network and collect beacon data from one or more nearby access points within wireless communication range. During promiscuous mode monitoring, network traffic monitor 210 can discover available access points within range and connect to one or more open wireless networks 116 to obtain network traffic data. The obtained network traffic may be buffered or stored or sent directly as input data to ML engine 230 and statistical analyzer 240. In one example, the obtained network traffic may be buffered or stored in data storage system 270. Data manager 220 may process the obtained network traffic data for storage in data storage system 270, and then retrieve stored data for use as input data to ML engine 230 and statistical analyzer 240.

To detect an AP attack, the input data is then processed by both ML engine 230 and statistical analyzer 240. In one embodiment, inference stage 234 performs feature engineering on the input data prior to applying the trained ML model 272 to obtain the predicted value representative of a likelihood of the occurrence of an access point attack. The feature engineering takes into account one or more packet capture access point (PCAP) features. The PCAP features may include one or more of the twenty-four features shown in TABLE 1 described in further detail below. Statistical analyzer 240 calculates a decision score (DS) which is a function of a multi-hop detection (MHD) value, trace route (TR) value, round-trip time (RTT) value, and beacon and probe response time (BPRFS) value. The DS calculation is described in further detail below. The statistical analyzer 240 may further obtain the confidence value based on a comparison of the calculated DS score to a normalized DS for benign access point traffic such that the confidence value further indicates a degree of confidence based on the variance of the calculated DS score in the event of malicious activity at an access point compared to benign activity in network traffic at an access point.

Training stage 232 can be used to carry out training to obtain trained ML model 272. In one embodiment, training stage 232 performs feature selection on training data using one or more PCAP features. The PCAP features may include one or more of the twenty-four features in TABLE 1. Training stage 232 can train using training data that includes authorized data drawn from public and/or private datasets. Training stage 232 may also perform discretization, cleaning and normalization of the training data prior to feature selection.

In one embodiment, training stage 232 divides the training data into a training data set, validation data set and test data set. Training stage 232 then trains an interim model using the training data set, tunes the interim model with the validation data set, tests the validated interim model with the test data set to obtain a final trained ML model. In still other embodiments, ML engine 230 can simply upload or access a previously generated trained ML model 272.

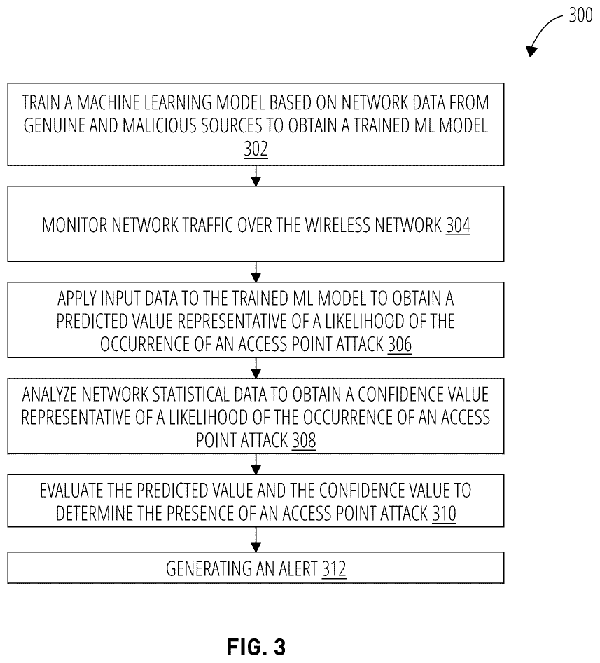

FIG. 3 illustrates a method 300 for detecting an access point attack over a wireless network having an access point in accordance with one embodiment (steps 302-312). In step 302, a machine learning model is trained based on network data from genuine and malicious sources to obtain a trained ML model. In step 304, network traffic over the wireless network is monitored. In step 306, input data is applied to the trained ML model to obtain a predicted value representative of a likelihood of the occurrence of an access point attack. In step 308, network statistical data is analyzed to obtain a confidence value representative of a likelihood of the occurrence of an access point attack. In step 310, the predicted value and the confidence value are evaluated to determine the presence of an access point attack. In step 312, an alert is generated.

In one embodiment, method 300 may be performed by AP attack detection system 120. Training step 302 may be carried out as a pre-processing step in advance of attack detection operation. Steps 304-312 may then be performed during operation to detect the presence of an access point attack.

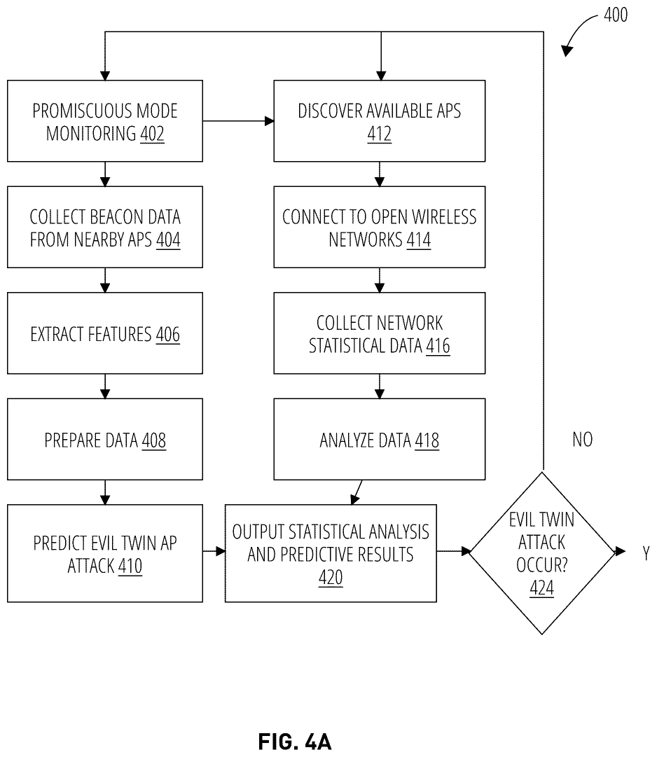

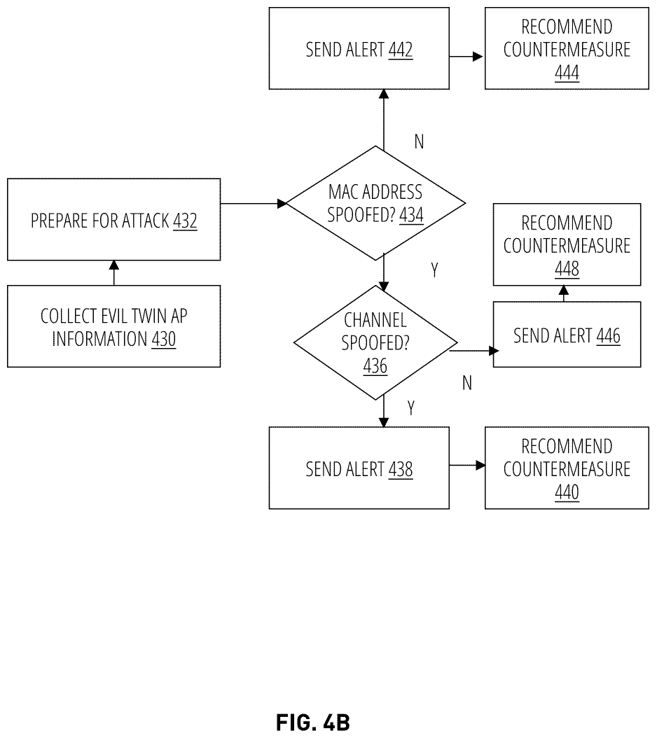

The operation of AP attack detection system 120 and its components and further methods are described further below with respect to the processes shown in FIGS. 4A, 4B, and 5-7.

FIGS. 4A and 4B are a flowchart diagram of an AP attack detection method 400 in accordance with an embodiment (steps 402-448). For brevity, the method is described with reference to example threats and AP attack detection system 120 and its components, however the method is not intended to be limited to AP attack detection system 120 and can be used with other system configurations and AP attack threats.

First, operation begins by initiating promiscuous mode monitoring (step 402). For example, AP attack detection system 120 may be placed in an area (such as a company lobby or public space) where an evil twin AP attack threat exists. Communication unit 204 for example may switch a network device (such as network interface unit) to operate in a promiscuous mode which captures and reads all wireless network traffic data not just network traffic data with a particular destination address. In promiscuous mode, communication unit 204 may also intercept and read the entirety of each packet in packet data carried in the network traffic. A packet processor in communication unit 204 may parse packet data in wireless traffic and capture all frame data. For example, this frame data may be frame data provided according to a Wi-Fi standard.

To aid machine learning prediction, beacon data and probe data are collected from nearby access points (step 404). For example, beacon frames are received and parsed by communication unit 204 to obtain beacon data. A transceiver and network interface (radio NI) in communication unit 204 may scan radio frequencies (RF) to search for beacons that announce that presence of a nearby access point. When the radio NI receives a beacon frame for an access point of a particular network it can determine information about the capabilities and configuration of the particular wireless network. Likewise, probe data in response to probe requests is received and parsed by communication unit 204 to obtain probe data. A probe request may be sent to an access point which returns a probe response with probe data advertising Service Set Identifier (SSID), supported data rates, encryption types or other 802.11 capabilities of an access point. Communication unit 204 may output the beacon data and probe data to data manager 220 for storage or further processing.

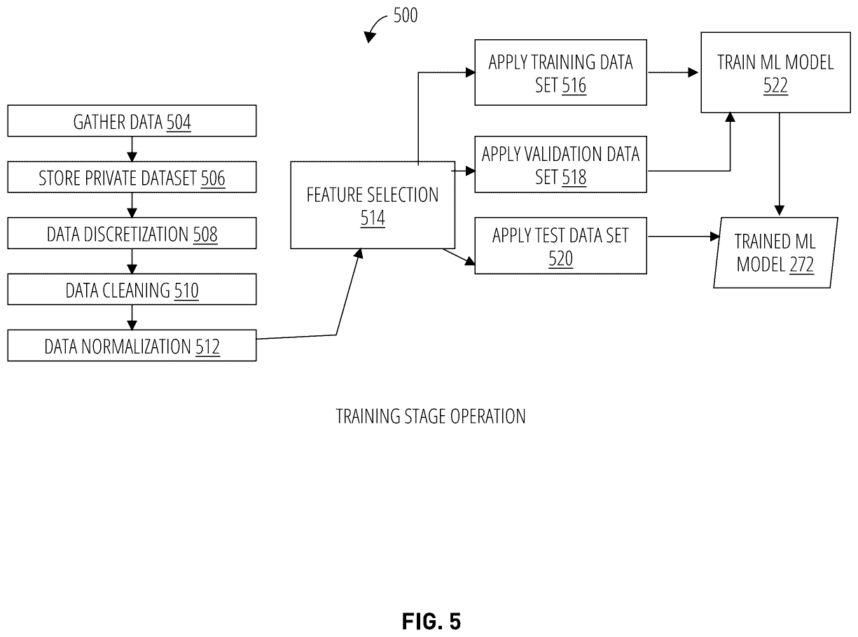

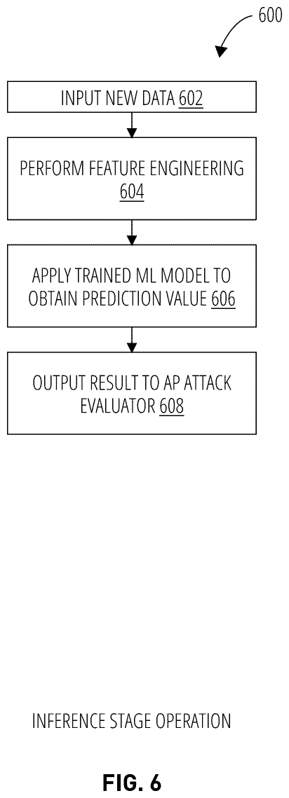

In one embodiment, ML engine 230 inputs the received beacon data and probe date to inference stage 234. Inference stage 234 then evaluates the received beacon data and probe data and extracts one or more features (step 406). Inference stage 234 then prepares data according to the extracted features for input to trained ML model 272 (step 408). This data preparation may include feature engineering and other processing suitable for input to trained ML model 272. Trained ML model 272 then generates a predicted value (step 410). Operation of training stage 232 and inference stage 234 is described in further detail below with respect to FIGS. 5 and 6 respectively.

To support statistical analysis, available access points within range of AP attack detection system 120 are discovered (step 412). For example, a transceiver and network interface (radio NI) in communication unit 204 may scan radio frequencies (RF) to search for beacons that announce that presence of a nearby access point. When the radio NI receives a beacon frame for an access point of a particular network it can determine information about the capabilities and configuration of the particular wireless network. For example, access points 100, 102 may transmit respective beacon frames periodically. In a Wi-Fi network, beacon frames are a type of management frame and have a MAC header, body fields, and a frame check sequence according to an 802.11 standard. Body fields can include SSID, security capabilities, channel information, supported bit rates, timestamp, beacon interval, capability information, parameter sets, and a traffic indication map. In this way, different available access points and relative signal strength can be discovered.

Communication unit 204 connects to open wireless networks through the discovered access points to receive network traffic data (step 414). Communication unit 204 outputs the obtained network data to network traffic monitor 210 for collection. Network traffic monitor 210 collects all the obtained network traffic data and outputs it to data manager 220 for storage in data storage system 270 (step 416). In a further example, network traffic monitor 210 can buffer, store or direct obtained network traffic data to statistical analyzer 240.

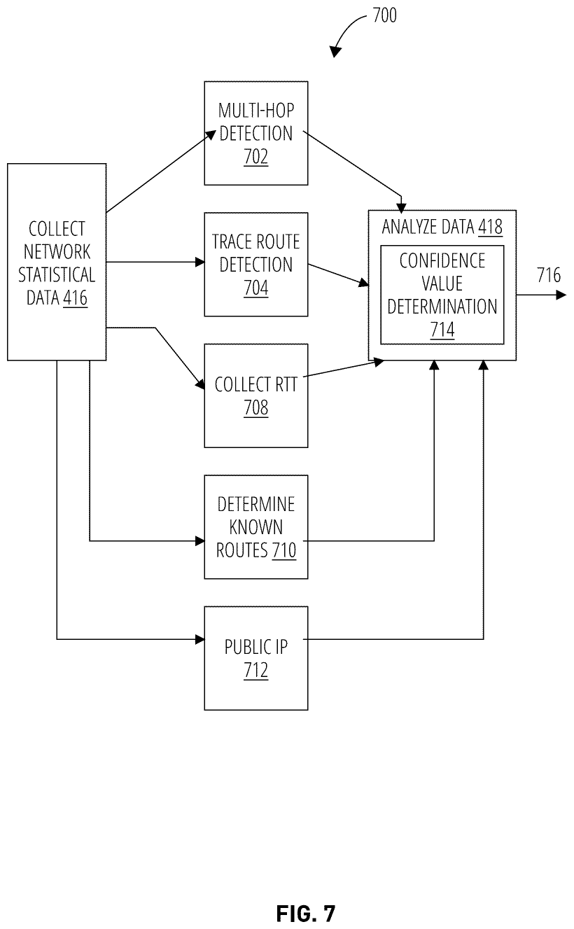

In step 418, statistical analyzer 240 generates and analyzes network statistical data relating to the collected network traffic data. Statistical analyzer 240 analyzes the network statistical data to obtain a confidence value representative of a likelihood of the occurrence of an access point attack. In one embodiment, statistical analyzer 240 calculates a decision score (DS). The DS is a function of a multi-hop detection (MHD) value, trace route (TR) value, round-trip time (RTT) value, and beacon and probe response time (BPRFS) value as described in further detail below with respect to FIG. 7. A confidence value is then obtained based on a comparison of the calculated DS score to a normalized DS for benign access point traffic. In this way in the example of FIG. 1, the confidence value generated by statistical analyzer 240 indicates a degree of confidence based on the variance of the calculated DS score in the event of malicious activity at access point 102 compared to benign activity in network traffic at access point 100.

In step 420, the confidence value obtained in step 418 and the predictive result obtained in step 410 are output for evaluation. For example, access point attack evaluator 250 can receive the predicted value and the confidence value to determine the presence of an access point attack. Access point attack evaluator 250 can retrieve the predicted value and the confidence value from data storage system 270 or receive directly from statistical analyzer 240 and ML engine 230.

In step 424, the obtained confidence value and predictive value are evaluated to determine whether an evil twin AP attack is present. If no, control proceeds to steps 402 and 412 to continue promiscuous mode monitoring and discovery of available access points. If yes, an evil twin AP attack is present, control proceeds to step 430 in FIG. 4B for further action such as alert generation and countermeasure recommendation. In one example, access point attack evaluator 250 can perform step 424 and evaluate the predicted value and the confidence value to determine the presence of an access point attack.

If both machine learning and statistical analysis output indicate the presence of an evil twin attack, then additional verification will be conducted.

As shown in FIG. 4B, evil twin AP information is collected (step 430) and used to prepare for an attack (step 432). The collected evil twin AP information is the access point information associated with presence of an attack as determined in step 424. For example, access point information about malicious AP 102 may be collected. Such evil twin AP information may include the MAC address and channel information of the access point associated with the evil twin attack. The evil twin AP information is then evaluated to prepare for or mitigate damage from an attack.

In one feature, control proceeds to step 434 to check if the MAC address has been spoofed. If no, then control proceeds to send an alert (step 442), and recommend a countermeasure (step 444). Otherwise, if yes a MAC address has been spoofed, then control proceeds to check is a channel has been spoofed (step 436).

If yes the channel has been spoofed, then control proceeds to send an alert (step 438), and recommend a countermeasure (step 440). If no, the channel has not been spoofed, then control proceeds to send an alert (step 446), and recommend a countermeasure (step 448).

In one embodiment, step 430-448 may be performed by alert generator 260. Alert generator 260 compares the captured MAC address and channels with known benign MAC address and channels. If the MAC address is spoofed, alert generator 260 will see the channel of both access points (legitimate acces point 100 and evil twin access point 102). If the channel is spoofed, alert generator 260 launches a priority algorithm to compare the statistical analysis confidence value and the machine learning predictive value. Alert generator 260 alerts users of the occurrence of the attack or sends a high-confidence alert that requires escalation, such as a security team investigation. Alert generator 260 may invoke and use a host discovery tool on a server to get MAC addresses of all users connected to the legitimate access point 100. Further, an administrator can supply all email addresses for each MAC address connected to the network (such as in a corporate environment), and when the host discovery tool gets all MAC addresses of connected devices 110, an alarm will be sent for only the connected devices for containment and privacy matters.

The alerts and recommended countermeasures may vary depending upon whether the MAC address and/or channel has been spoofed. For example, each alert may indicate an evil twin AP attack has been detected or is likely present. Each countermeasure may also recommend a denial of service (DoS) attack be initiated by a benign access point 100 so that the malicious evil twin access point 102 cannot continue to gather traffic data.

### Training Stage Operation

FIG. 5 is a flowchart diagram showing training stage operation 500 in machine learning in accordance with one embodiment (steps 504-522). Training is carried out by training stage 232 to obtain a trained ML model 272.

In step 504, training data is gathered from one or more sources. In one embodiment, authorized training data is gathered from public and/or private proprietary sources. In step 506, a private data set is stored securely and separate from the public data set.

Data preparation is carried out to further prepare the training data (steps 508-512). For example, both public and private datasets undergo data discretization (step 508), data cleaning (510), and data normalization (step 512). Other data pre-processing may also be performed. These data preparation steps ultimately help the ML engine 230 differentiate between legitimate users and malicious actors when the trained ML model 272 is obtained.

In step 514, feature selection is performed prior to a division of the training data into training, validation, and test data sets. Such feature selection can use a set of features as described below, In step 516, training stage 232 applies the training data set to a machine learning algorithm to train a ML model (step 522). In step 518, training stage 232 applies the validation set to tune the ML model. In step 520, training stage 232 applies the test set to evaluate the ML model, which, once finalized, is output as trained ML model 272 for predicting new data.

### PCAP Feature Set

In a further aspect, feature selection is performed using a selection from a set of PCAP features. This generates a trained ML model 272 for detecting normal and abnormal AP traffic with improved model performance and training. In one embodiment, a comprehensive set of 24 PCAP features is used selected by inventors to efficiently identify an evil twin AP attack. These features have been identified as essential to the nuanced demands of wireless network analysis and have demonstrated their value in enhancing the predictive capabilities of machine learning models within the cybersecurity domain.

The table below lists each of these selected 24 PCAP features by name along with its data type and a description.

TABLE 1

| | Machine Learning Features | | |
|---|---|---|---|
| No. | Feature | Datatype | Description |
| 1 | frame.encap_type | Integer | Type of packet encapsulation. |
| 2 | frame.len | Integer | Length of the entire packet frame. |
| 3 | frame.number | Integer | Unique number assigned to the frame. |
| 4 | frame.time_epoch | Double | Time the frame was captured. |
| 5 | frame.time_relative | Double | Time elapsed since the start of the |
| | | | packet capture. |
| 6 | radiotap.channel.freq | Integer | Frequency of the channel that the |
| | | | frame was transmitted on. |
| 7 | radiotap.datarate | Integer | Data rate at which the frame was |
| | | | transmitted. |
| 8 | radiotap.length | Integer | Length of the radiotap header |
| 9 | radiotap.mactime | Double | Time the frame was transmitted since |
| | | | the start of the unix epoch. |
| 10 | radiotap.timestamp.ts | Double | Start time synchronization function |
| | | | value for the frame transmission. |
| 11 | wlan.duration | Double | Duration of the frame transmission. |
| 12 | wlan.fc.subtype | Integer | Frame control field in the 802.11 header. |
| 13 | wlan_radio.duration | Double | Duration of the frame transmission, |
| | | | expressed in microseconds. |
| 14 | wlan_radio.channel | Integer | Channel that the frame was transmitted |
| | | | on. |
| 15 | wlan_radio.data_rate | Integer | Data rate at which the frame was |
| | | | transmitted. |
| 16 | wlan_radio.end_tsf | Double | End time synchronization function value |
| | | | for the frame transmission. |
| 17 | wlan_radio.frequency | Integer | Center frequency of the channel that |
| | | | the frame was transmitted on. |
| 18 | wlan_radio.start_tsf | Double | Start time synchronization function |
| | | | value for the frame transmission. |
| 19 | wlan_radio.phy | Double | Physical layer protocol used in the |
| | | | transmission of the frame. |
| 20 | wlan_radio.timestamp | Double | Time the frame was captured, expressed |
| | | | as the number of microseconds. |
| 21 | wlan.ssid | String | Service set identifier of the wireless |
| | | | network. |
| 22 | wlan.fixed.capabilities.privacy | Integer | Indicates whether the network uses |
| | | | encryption. |
| 23 | wlan.fixed.capabilities | Integer | Capabilities of the wireless network. |
| 24 | radio_measurement | Integer | Set of parameters used to measure various |
| | | | aspects of the wireless radio environment. |

In addition, the list below describes each of the selected PCAP features in Table 1 and the main benefits of using them to develop and create a machine learning model in an embodiment:
frame.encap_type (Integer):
   Differentiates between various packet encapsulation types, helping identify anomalies in the packet structure that may indicate an evil twin attack.
frame.len (Integer):
   Anomalously large or small packet lengths may suggest unusual data transmission patterns, potentially indicative of malicious activity.
frame.number (Integer):
   Provides a unique identifier for each frame, aiding in tracking and analyzing individual packets to detect patterns associated with evil twin attacks.
frame.time_epoch (Double):
   Allows for temporal analysis, identifying abnormal patterns in the timing of packet transmissions, which could indicate the presence of an evil twin.
frame.time_relative (Double):
   Helps in analyzing the time elapsed between packet transmissions, aiding in the detection of irregularities or suspicious timing patterns.
radiotap.channel.freq (Integer):
   Benefit: Identifies the frequency of the channel used for frame transmission, helping to detect deviations from expected wireless network behavior.
radiotap.datarate (Integer):
   Anomalous data rates may indicate malicious interference, as evil twin attacks may manipulate data rates to disrupt legitimate network communication.
radiotap.length (Integer):
   The length of the radiotap header provides information about the structure of the radio frame, aiding in the identification of abnormalities associated with evil twin attacks.
radiotap.mactime (Double):
   Offers timing information related to frame transmission, assisting in the analysis of temporal patterns associated with evil twin attacks.
radiotap.timestamp.ts (Double):
   The start time synchronization function value aids in precise time-based analysis, helping to identify abnormal temporal patterns.
wlan.duration (Double):
   Duration of the frame transmission provides insights into the time taken for the wireless transmission, aiding in identifying unusual patterns associated with evil twin attacks.
wlan.fc.subtype (Integer):
   The frame control subtype field in the 802.11 header helps distinguish between different frame types, contributing to the identification of abnormal frame behaviors indicative of an evil twin.
wlan_radio.duration (Double):
   Similar to wlan.duration, the duration in the wlan_radio layer provides an additional perspective on the time taken for frame transmission, enhancing temporal analysis.
wlan_radio.channel (Integer):
   Identifies the channel used for frame transmission, allowing for the detection of deviations from the expected channel usage, which could indicate an evil twin attack.
wlan_radio.data_rate (Integer):
   Anomalous data rates in the wlan_radio layer can be indicative of interference or manipulation, providing valuable information for identifying evil twin attacks.
wlan_radio.end_tsf (Double):
   The end time synchronization function value aids in precise time-based analysis, contributing to the understanding of temporal patterns associated with Evil Twin attacks.
wlan_radio.frequency (Integer):
   The center frequency of the channel used for frame transmission helps in identifying abnormal frequency usage patterns, a potential sign of an evil twin.
wlan_radio.start_tsf (Double):
   Similar to end_tsf, start time synchronization function value contributes to precise time-based analysis, assisting in the identification of abnormal temporal patterns.
wlan_radio.phy (Double):
   Indicates the physical layer protocol used, aiding in the detection of anomalies or manipulations in the wireless transmission associated with evil twin attacks.
wlan_radio.timestamp (Double):
   Provides the time the frame was captured in microseconds, offering another time-based feature for analysis to detect temporal patterns associated with Evil Twin attacks.
wlan.ssid (String):
   Analyzing the Service Set Identifier (SSID) helps identify inconsistencies in network names, which can be indicative of evil twin attacks attempting to mimic legitimate networks.
wlan.fixed.capabilities.privacy (Integer):
   Indicates whether the network uses encryption, and changes in this feature may suggest attempts to manipulate privacy settings, a behavior associated with evil twin attacks.
wlan.fixed.capabilities (Integer):
   Provides information about the capabilities of the wireless network, helping in the detection of abnormal network behavior associated with evil twin attacks.
radio_measurement (Integer):
   The set of parameters used to measure aspects of the wireless radio environment can be leveraged to identify anomalies or disruptions in the radio environment caused by an evil twin attack.

### Inference Stage Operation

FIG. 6 is a flowchart diagram showing inference stage operation 600 in machine learning in accordance with one embodiment (steps 602-608). In step 602, new data is input to inference stage 234. The new data may be data extracted from collected network traffic. For example, raw network data may be data from collected network data 282.

In step 604, feature engineering is performed. For example, inference stage 234 may select and transform raw network traffic data to obtain relevant input data for applying to trained ML model 272. This selection includes selecting features drawn from the set of PCAP features in Table 1 as described above. In step 606, the trained ML model 272 is applied to obtain a prediction value. The prediction value is output to AP attack evaluator 250.

In embodiments, ML engine 230 may use a machine learning model having a multi-layer neural network. For example, multiple hidden layers may be provided between an input layer and output layer in one multi-later neural network (NN). Training may use multiple repetitions starting with an initial model and for each successive repetition using weight inputs obtained from a prior pass as parameters to the model until a number of repetitions are performed and a final trained model is obtained. Parameters and other values may be used to set a loss function and further govern training of a ML model. ML engine 230 may use deep learning techniques to train a ML model as described herein.

### Statistical Analysis Operation

FIG. 7 is a flowchart diagram showing statistical analysis operation 700 in further detail in accordance with one embodiment. In particular, operation 700 includes steps for generating network statistical data (steps 702-712) and confidence value determination (step 714) which can be carried out by statistical analyzer 240.

As shown in FIG. 7, statistical analyzer 240 generates networks statistics which can be used to detect evil twin AP attacks. The network statistics may be generated using multi-hop detection (step 702) and trace route detection (step 704) and by measuring the Round-Trip Time (RTT) of packets (step 708). Known routes may also be determined (step 710) and public IP data collected (step 712).

Multi-hop detection counts the number of hops a packet takes in a path. For example, network packets may travel through routers in a Local Area Network (NAN) on the path they take from a device 110 to an access point 100, 102. If there are multiple stops this indicates that the packets did not reach the legitimate access point 100 first.

Trace route detection is a scheme that determines the number of stops in each station. This type of information can be beneficial if the evil twin access point 102 connects to the Internet. By collecting information of the IP (Internet Protocol) of each stop that the legitimate access point 100 sends the network packet to, this would reveal any change in the appropriate stations if connected to an evil twin access point 102, because the evil twin access point 102 would use other stations.

RTT is the time a packet takes to travel from a client device to a destination server. For example, in a wireless network 116 having a server, measuring RTT allows measurement of the amount of time it takes for the legitimate packets to travel from a client device to a server (such as a company webserver) and allows measurement of the difference compared to a potential evil twin access point 102.

Packet size information may also be used. The collected network data in step 416 may collect beacon and probe response packet sizes to differentiate between legitimate and malicious access points. Beacon and probe response frame size data differs from one access point to another, depending on the access point itself. Bu using monitor mode to collect beacon and probe response packets from the sniffed networks, legitimate and evil twin access points 100, 102 can be differentiated and identified.

Data analysis step 418 also includes a confidence value determination (step 714) which outputs a confidence value 716. To determine a confidence value 716, statistical analyzer 240 first calculates a decision score (DS) which is a function of a multi-hop detection (MHD) value, trace route (TR) value, round-trip time (RTT) value, and beacon and probe response time (BPRFS) value. In one embodiment, DS is calculated according to the following equation:

$$Decision Score ( DS ) = ( MHD ) + ( TR ) + ( RTT ) + ( BPRFS ) \qquad \{ EQ . 1 \}$$

### Where:

DS is the Decision Score, a quantified measure of network efficiency;
MHD represents the Multi-hop Detection value, which reflects the number of hops and the quality of the multi-hop path;
TR stands for Trace Route, indicating the path and intermediate nodes involved from source to destination;
RTT denotes the Round-Trip Time, measuring the time a signal takes to go to a destination and back; and
BPRFS is the Beacon and Probe Response Frame Size, indicating the overhead induced by the management frames.

The value of the calculated DS is compared to a normalized behavior DS value from benign AP traffic. A confidence value 716 is then determined based on the magnitude of the comparison so as to obtain a value representative of variance between benign and the malicious AP activity.

### Further Computer-Implemented Embodiments

Devices 110 and computing device 206 can be any type of computing device including, but not limited to, a smartphone, laptop, desktop, tablet, workstation, kiosk or other computing device having at least one processor and a non-transitory computable readable memory. Devices 110 and computing device 206 may include a browser, application, and operating system along with a user-interface depending upon a desired configuration. ML engine 230 may also be implemented on computing device 206 or other remote computing devices at the same or different locations.

Computing device 206 and each of its components may have functionality performed at the same or different physical locations and by one or more processors located at the same or different locations. Computing device 206 many also be coupled to over a network interface to remote computing devices to perform aspects of the functionality described herein. For example, computing device 206 may communicate with a remote computing device or platform having a library or other functionality to implement ML engine 230 and perform the machine learning operations as described herein. For example, computing device 206 may place a function call, API request, or other request to a remote ML engine 230.

Similarly, other components shown in FIG. 2, network traffic monitor 210, data manager 220, statistical analyzer 240, AP attack evaluator 250, alert generator 260 and controller 280 may have their functionality distributed across the same or different physical locations and by one or more processors located at the same or different locations, and which can be accessed by a function call, API request, or other request.

Computing functionality as described herein may also be implemented on a server, cluster of servers, web server, cloud-computing platform and/or other remote service. A client/server architecture may also be implemented as would be apparent to a person skill in the art given this description.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

The present disclosure is also directed to the following exemplary embodiments, which can be practiced in any combination thereof:

Embodiment A disclosed herein includes a system for detecting an access point attack over a wireless network having an access point, comprising: a network traffic monitor configured to monitor traffic over the wireless network; a machine learning engine having a training stage and an inference stage, wherein the training stage is configured to generate a trained machine learning (ML) model based on network data from genuine and malicious sources and the inference stage is configured to apply the trained ML model to input data to obtain a predicted value representative of a likelihood of an occurrence of an access point attack; a statistical analyzer configured to analyze network statistical data to obtain a confidence value representative of a likelihood of the occurrence of an access point attack; and an access point attack evaluator configured to evaluate the predicted value and the confidence value to determine a presence of an access point attack, wherein the network traffic monitor, machine learning engine, statistical analyzer, and access point attack evaluator are each implemented on at least one processor.

Embodiment A may have one or more of the following additional elements A1-A14 in any combination or all the elements in a combination. Element A1 wherein the access point attack comprises an evil twin access point attack. Element A2 further comprising an alert generator configured to generate an alert indicative of the presence of an access point attack based on output from the access point attack evaluator. Element A3 wherein the access point attack evaluator is further configured to determine whether at least one of an address or a channel of an access point device is spoofed. Element A4 wherein the network traffic monitor is further configured to initiate promiscuous mode monitoring of network traffic on the wireless network and to collect beacon data from one or more nearby access points within wireless communication range. Element A5 wherein during promiscuous mode monitoring, the network traffic monitor is further configured to discover available access points and connect to one or more open wireless networks to obtain network traffic data. Element A6 wherein the training stage is further configured to perform feature selection on training data using one or more packet capture access point (PCAP) features. Element A7 wherein the PCAP features include one or more of twenty-four features recited in TABLE 1. Element A8 wherein the training stage is further configured to train using training data that include public and private datasets. Element A9 wherein the training stage is further configured to perform discretization, cleaning and normalization of the training data prior to feature selection. Element A10 wherein the training stage is further configured to divide the training data into a training data set, validation data set and test data set, and wherein the training stage trains an interim model using the training data set, tunes the interim model with the validation data set, tests the validated interim model with the test data set to obtain a final trained ML model. Element A11 wherein the input data includes network traffic data from the wireless network and the inference stage is further configured to perform feature engineering on the input data prior to applying the trained ML model to obtain the predicted value representative of a likelihood of the occurrence of an access point attack, wherein the feature engineering takes into account one or more PCAP features. Element A12 wherein the statistical analyzer is further configured to calculate a decision score (DS) which is a function of a multi-hop detection (MHD) value, trace route (TR) value, round-trip time (RTT) value, and beacon and probe response time (BPRFS) value. Element A13 wherein the statistical analyzer is further configured to obtain the confidence value based on a comparison of the calculated DS score to a normalized DS for benign access point traffic such that the confidence value further indicates a degree of confidence based on a variance of the calculated DS score in the event of malicious activity at an access point compared to benign activity in network traffic at an access point. Element A14 further comprising a data manager coupled to a data storage system, wherein the data storage system stores collected network statistical data and the trained ML model.

Embodiment B disclosed herein includes a method for detecting an access point attack over a wireless network having an access point, comprising: training a machine learning model based on network data from genuine and malicious sources to obtain a trained ML model; monitoring network traffic over the wireless network; applying input data to the trained ML model to obtain a predicted value representative of a likelihood of the occurrence of an access point attack; analyzing network statistical data to obtain a confidence value representative of a likelihood of the occurrence of an access point attack; and evaluating the predicted value and the confidence value to determine the presence of an access point attack.

Embodiment B may have one or more of the following additional elements B1-B8 in any combination or all in combination: Element B1 includes generating an alert indicative of the presence of an access point attack based on the evaluating. Element B2 wherein the evaluating further includes determining whether at least one of an address or a channel of an access point device is spoofed. Element B3 wherein the training includes performing feature selection on training data using one or more packet capture access point (PCAP) features. Element B4 wherein the PCAP features include one or more of twenty-four features recited in TABLE 1. Element B5 wherein the input data includes network traffic data from the wireless network, and further comprising performing feature engineering on the input data prior to applying the trained ML model, wherein the feature engineering takes into account one or more PCAP features. Element B6 wherein the analyzing includes calculating a decision score (DS) which is a function of a multi-hop detection (MHD) value, trace route (TR) value, round-trip time (RTT) value, and beacon and probe response time (BPRFS) value. Element B7 wherein the analyzing further includes comparing the calculated DS score to a normalized DS for benign access point traffic such that the obtained confidence value further indicates a degree of confidence based on a variance of the calculated DS score in the event of malicious activity at an access point compared to benign activity in network traffic at an access point. Element B8 further comprising storing collected network statistical data and the trained ML model in a data storage system.

Embodiment C disclosed herein includes a system for detecting an access point attack over a wireless network having an access point, comprising: means for monitoring network traffic over the wireless network; means for training a machine learning model based on network data from genuine and malicious sources to obtain a trained ML model; means for applying input data to the trained ML model to obtain a predicted value representative of a likelihood of the occurrence of an access point attack; means for analyzing network statistical data to obtain a confidence value representative of a likelihood of the occurrence of an access point attack; and means for evaluating the predicted value and the confidence value to determine the presence of an access point attack.

Embodiment C may have one or more of the following additional element C1 in any combination or all in combination: Embodiment C1 further comprising means for generating an alert indicative of the presence of an access point attack.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,”, “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A system for detecting an access point attack over a wireless network having an access point, comprising:
a network traffic monitor configured to monitor traffic over the wireless network;
a machine learning engine having a training stage and an inference stage, wherein the training stage is configured to generate a trained machine learning (ML) model based on network data from genuine and malicious sources and the inference stage is configured to apply the trained ML model to input data to obtain a predicted value representative of a likelihood of an occurrence of an access point attack;
a statistical analyzer configured to analyze network statistical data to obtain a confidence value representative of a likelihood of the occurrence of an access point attack; and
an access point attack evaluator configured to evaluate the predicted value and the confidence value to determine a presence of an access point attack,
wherein the network traffic monitor, machine learning engine, statistical analyzer, and access point attack evaluator are each implemented on at least one processor.

2. The system of claim 1, wherein the access point attack comprises an evil twin access point attack.

3. The system of claim 1, further comprising an alert generator configured to generate an alert indicative of the presence of an access point attack based on output from the access point attack evaluator.

4. The system of claim 3, wherein the access point attack evaluator is further configured to determine whether at least one of an address or a channel of an access point device is spoofed.

5. The system of claim 1, wherein the network traffic monitor is further configured to initiate promiscuous mode monitoring of network traffic on the wireless network and to collect beacon data from one or more nearby access points within wireless communication range.

6. The system of claim 5, wherein during promiscuous mode monitoring, the network traffic monitor is further configured to discover available access points and connect to one or more open wireless networks to obtain network traffic data.

7. The system of claim 1, wherein the training stage is further configured to perform feature selection on training data using one or more packet capture access point (PCAP) features.

8. The system of claim 7, wherein the PCAP features include one or more of twenty-four features recited in TABLE 1.

9. The system of claim 7, wherein the training stage is further configured to train using training data that include public and private datasets.

10. The system of claim 7, wherein the training stage is further configured to perform discretization, cleaning and normalization of the training data prior to feature selection.

11. The system of claim 7, wherein the training stage is further configured to divide the training data into a training data set, validation data set and test data set, and wherein the training stage trains an interim model using the training data set, tunes the interim model with the validation data set, tests the validated interim model with the test data set to obtain a final trained ML model.

12. The system of claim 11, wherein the input data includes network traffic data from the wireless network and the inference stage is further configured to perform feature engineering on the input data prior to applying the trained ML model to obtain the predicted value representative of a likelihood of the occurrence of an access point attack, wherein the feature engineering takes into account one or more PCAP features.

13. The system of claim 7, wherein the statistical analyzer is further configured to calculate a decision score (DS) which is a function of a multi-hop detection (MHD) value, trace route (TR) value, round-trip time (RTT) value, and beacon and probe response time (BPRFS) value.

14. The system of claim 13, wherein the statistical analyzer is further configured to obtain the confidence value based on a comparison of the calculated DS score to a normalized DS for benign access point traffic such that the confidence value further indicates a degree of confidence based on a variance of the calculated DS score in the event of malicious activity at an access point compared to benign activity in network traffic at an access point.

15. The system of claim 1, further comprising a data manager coupled to a data storage system, wherein the data storage system stores collected network statistical data and the trained ML model.

16. A method for detecting an access point attack over a wireless network having an access point, comprising:
training a machine learning model based on network data from genuine and malicious sources to obtain a trained ML model;
monitoring network traffic over the wireless network;
applying input data to the trained ML model to obtain a predicted value representative of a likelihood of the occurrence of an access point attack;
analyzing network statistical data to obtain a confidence value representative of a likelihood of the occurrence of an access point attack; and
evaluating the predicted value and the confidence value to determine the presence of an access point attack.

17. The method of claim 16, further including generating an alert indicative of the presence of an access point attack based on the evaluating, and wherein the evaluating further includes determining whether at least one of an address or a channel of an access point device is spoofed.

18. The method of claim 17, wherein the training includes performing feature selection on training data using one or more packet capture access point (PCAP) features, wherein the PCAP features include one or more of twenty-four features recited in TABLE 1.

19. The method of claim 16, wherein the analyzing includes calculating a decision score (DS) which is a function of a multi-hop detection (MHD) value, trace route (TR) value, round-trip time (RTT) value, and beacon and probe response time (BPRFS) value.

20. A system for detecting an access point attack over a wireless network having an access point, comprising:
means for monitoring network traffic over the wireless network;
means for training a machine learning model based on network data from genuine and malicious sources to obtain a trained ML model;
means for applying input data to the trained ML model to obtain a predicted value representative of a likelihood of the occurrence of an access point attack;
means for analyzing network statistical data to obtain a confidence value representative of a likelihood of the occurrence of an access point attack;
means for evaluating the predicted value and the confidence value to determine the presence of an access point attack; and means for generating an alert indicative of the presence of an access point attack.
